(19) United States
(12) Patent Application Publication
(10) Pub. No.: US 2017/0310572 A1
(43) Pub. Date: Oct. 26, 2017

(54) TROUBLE DIAGNOSIS METHOD AND APPARATUS AND SYSTEM

(71) Applicant: FUJITSU LIMITED, Kawasaki-shi (JP)

(72) Inventors: Su YI, Beijing (CN); Hao WANG, Beijing (CN); Jun TIAN, Beijing (CN); Lefei WANG, Beijing (CN); Wenqian XUE, Beijing (CN); Xiaojing FAN, Beijing (CN); Ryuichi MATSUKURA, Kawasaki-shi (JP)

(21) Appl. No.: 15/478,987

(22) Filed: Apr. 4, 2017

(30) Foreign Application Priority Data
Apr. 21, 2016 (CN) 201610250527.9

(51) Int. Cl. H04L 12/26; H04L 5/00; H04L 29/08

(52) U.S. Cl. CPC H04L 43/50; H04L 69/324; H04L 67/12; H04L 5/0055; H04L 5/006; H04L 43/08

(57) ABSTRACT

Embodiments of this disclosure provide a trouble diagnosis method and apparatus and a system. The method includes: acquiring channel-related information on a coordinator and terminal equipment in communication with the coordinator; selecting multiple indices in the channel-related information, and calculating statistical values of the multiple indices in a predetermined period of time; and performing trouble diagnosis by using the statistical values and pre-stored training data, so as to obtain a trouble diagnosis result corresponding to the period of time. In the embodiments of this disclosure, by collecting the channel-related information on the coordinator and the terminal equipment in communication with the coordinator, doing statistics on the collected channel-related information, so as to perform trouble diagnosis by using a machine learning method, which may diagnose different troubles, and network service providers may make some countermeasures to solve the problem or avoid potential problems accordingly.

### FIELD

This disclosure relates to the field of communication technologies, and in particular to a trouble diagnosis method and apparatus and a system.

### BACKGROUND

The Internet of Things (IoT) has become a powerful force for business transformation, and its disruptive impact will be felt across all industries and all areas of society. The entities in IoT networks usually include sensors and devices, gateway, networks, cloud, applications, etc.

With this growing adoption of the technology and increasing dependence on WiFi, Zigbee, Bluetooth, and other wireless short-range networks, users are beginning to demand reliability, performance, scalability and ubiquitous coverage from the wireless networks. However, existing sensor network deployment provides inadequate coverage and unpredictable performance. The reasons leading to the degraded performance include dense deployment, noise and interference, RF effects such as hidden terminals, and limitations in the medium access control (MAC) layer. And unlike the wired counterpart, a wireless link is easily affected by environment changes or surrounding wireless activities. State monitoring and trouble diagnosis in both link level and network level are essential components to operate an IoT network.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

The inventors found that among all the troubles (faults) or errors, the most common and frequent ones are those related with wireless transmission. These errors are generally caused by random fading, low received signal strength, and interference. These root causes are common to all wireless short range networks. In addition, 802.11, 802.15.4, 802.15.1, etc. all operate in unlicensed frequency bands. Some issues like interference will be more critical since multiple systems may interfere with each other and the number of users in the unlicensed frequency bands is increasing rapidly. Interference is unpredictable because it is often generated by mobile users, other unlicensed frequency band modules and varying traffic. Therefore, real-time state monitoring and automated trouble detection are important for efficient operation and management services.

In order to solve the above problems, embodiments of this disclosure provide a trouble diagnosis method and apparatus and a system, in which by diagnosing different troubles, network service providers may make some countermeasures to solve the problem or avoid potential problems.

According to a first aspect of the embodiments of this disclosure, there is provided a trouble diagnosis apparatus, including:

an acquiring unit configured to acquire channel-related information on a coordinator and terminal equipment in communication with the coordinator;

a calculating unit configured to select multiple indices in the channel-related information, and calculate statistical values of the multiple indices in a predetermined period of time; and

a diagnosing unit configured to perform trouble diagnosis by using the statistical values and pre-stored training data, so as to obtain a trouble diagnosis result corresponding to the period of time.

According to a second aspect of the embodiments of this disclosure, there is provided a trouble diagnosis apparatus, including:

a receiving unit configured to receive a measurement request packet;

a measuring unit configured to perform channel measurement according to the measurement request packet; and

a transmitting unit configured to feed back a channel measurement result via a measurement response packet.

According to a third aspect of the embodiments of this disclosure, there is provided a coordinator, including the trouble diagnosis apparatus as described in the first aspect.

According to a fourth aspect of the embodiments of this disclosure, there is provided terminal equipment, including the trouble diagnosis apparatus as described in the second aspect.

According to a fifth aspect of the embodiments of this disclosure, there is provided a communication system, including the coordinator as described in the third aspect and the terminal equipment as described in the fourth aspect.

According to a sixth aspect of the embodiments of this disclosure, there is provided a trouble diagnosis method, including:

acquiring channel-related information on a coordinator and terminal equipment in communication with the coordinator;

selecting multiple indices in the channel-related information, and calculating statistical values of the multiple indices in a predetermined period of time; and

performing trouble diagnosis by using the statistical values and pre-stored training data, so as to obtain a trouble diagnosis result corresponding to the period of time.

According to a seventh aspect of the embodiments of this disclosure, there is provided a trouble diagnosis method, including:

receiving a measurement request packet;

performing channel measurement according to the measurement request packet; and

feeding back a channel measurement result via a measurement response packet.

An advantage of the embodiments of this disclosure exists in that with the method, apparatus and system of the embodiments of this disclosure, different troubles may be diagnosed, hence, network service providers may make some countermeasures to solve the problem or avoid potential problems accordingly.

With reference to the following description and drawings, the particular embodiments of this disclosure are disclosed in detail, and the principles of this disclosure and the manners of use are indicated. It should be understood that the scope of the embodiments of this disclosure is not limited thereto. The embodiments of this disclosure contain many alternations, modifications and equivalents within the spirits and scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising/includes/including” when used in this specification is taken to specify the presence of stated features, integers, steps or components but does not preclude the presence or addition of one or more other features, integers, steps, components or groups thereof.

### BRIEF DESCRIPTION OF THE DRAWINGS

The drawings are included to provide further understanding of this disclosure, which constitute a part of the specification and illustrate the preferred embodiments of this disclosure, and are used for setting forth the principles of this disclosure together with the description. It is obvious that the accompanying drawings in the following description are some embodiments of this disclosure, and for those of ordinary skills in the art, other accompanying drawings may be obtained according to these accompanying drawings without making an inventive effort. In the drawings:

FIG. 1 is a schematic diagram of a common architecture of a front-end management system of the Internet of Things;

FIG. 2 is a schematic diagram of a trouble diagnosis apparatus of Embodiment 1;

FIG. 3 is a schematic diagram of an acquiring unit in the trouble diagnosis apparatus of Embodiment 1;

FIG. 4 is a schematic diagram of a processing process of poll and echo;

FIG. 5 is another schematic diagram of the processing process of poll and echo;

FIG. 6 is a schematic diagram of an implementation of a data model of statistical data;

FIG. 7 is a schematic diagram of a diagnosing unit in the trouble diagnosis apparatus of Embodiment 1;

FIG. 8 is a schematic diagram of a trouble diagnosis apparatus of Embodiment 2;

FIG. 9 is a schematic diagram of a control entity of Embodiment 3;

FIG. 10 is a schematic diagram of terminal equipment of Embodiment 4;

FIG. 11 is a schematic diagram of topology of a communication system of Embodiment 5;

FIG. 12 is a schematic diagram of a trouble diagnosis method of Embodiment 6;

FIG. 13 is a schematic diagram of acquiring channel-related information in the method of Embodiment 6;

FIG. 14 is a schematic diagram of performing trouble diagnosis in the method of Embodiment 6; and

FIG. 15 is a schematic diagram of a trouble diagnosis method of Embodiment 7.

### DETAILED DESCRIPTION

These and further aspects and features of the present disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the terms of the appended claims.

The method of the embodiment of this disclosure can be applied to the Internet of Things, a sensor network, a wireless local area network (WLAN) and other wireless networks. In the embodiments of this disclosure, terminologies in the Internet of Things are used, and some contexts related to specifications are based on the IEEE 802.15.4 standard. Such an idea may be easily extended to other wireless communication systems and other wireless standards.

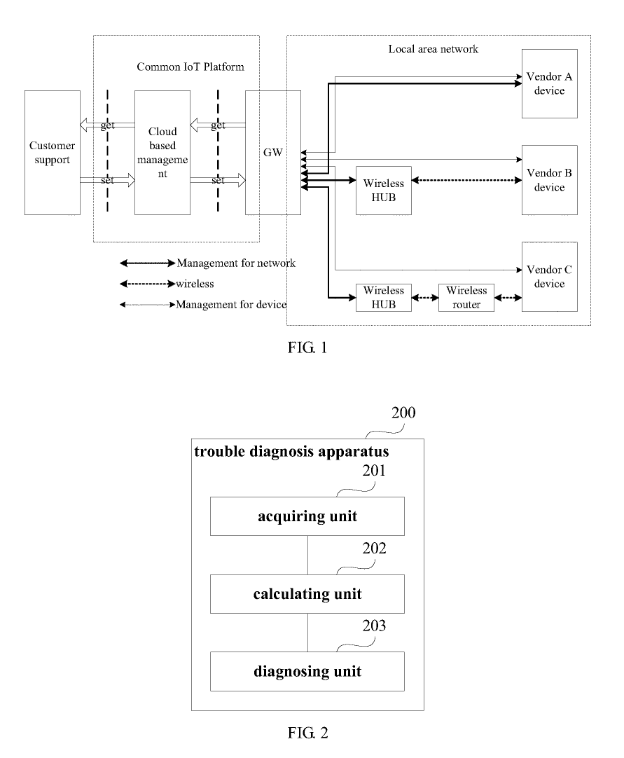

FIG. 1 is a schematic diagram of a common architecture of a front-end management system of the Internet of Things. As show in FIG. 1, a gateway (GW) supports a connection from a frond-end connection device to back-end application analysis. In particular, front-end devices for various applications and various network systems have different management needs, and the gateway provides a common application interface (API) for different devices, networks to cloud and customer support, so as to meet the application requirements of the customer. After the front-end devices (including an access point (AP), a hub, and a router, etc.) collect transceiver logs, these logs will be transmitted to the gateway. According to the application requirements and complexity of analysis, the gateway or cloud will perform trouble diagnosis and analysis.

The embodiments of this disclosure shall be described below with reference to the accompanying drawings and particular implementations.

### Embodiment 1

An embodiment of this disclosure provides a trouble diagnosis apparatus, applicable to a wireless network. For example, it may be configured in a coordinator, an access point, a hub, a gateway, a central controller, or cloud, etc., with its particular implementation being dependent on the wireless network. Following description is given taking that the apparatus is configured in a coordinator as an example only.

FIG. 2 is a schematic diagram of the apparatus. As show in FIG. 2, the apparatus 200 includes: an acquiring unit 201, a calculating unit 202 and a diagnosing unit 203. The acquiring unit 201 is configured to acquire channel-related information on a coordinator and terminal equipment in communication with the coordinator. The calculating unit 202 is configured to select multiple indices in the channel-related information, and calculate statistical values of the multiple indices in a predetermined period of time. And the diagnosing unit 203 is configured to perform trouble diagnosis by using the statistical values and pre-stored training data, so as to obtain a trouble diagnosis result corresponding to the period of time.

In this embodiment, the coordinator refers to a network entity having a function of coordination in the wireless network, such as a coordinator, an access point, and a hub, etc., which may be named differently according to different types of wireless networks. In this embodiment, description is given taking a coordinator as an example; however, it is not limited thereto. In this embodiment, the terminal equipment refers to node in the wireless network, such as a station, and a node, etc.; likewise, it may be named differently according to different types of wireless networks. For the sake of convenience of description, they are collectively named as terminal equipment.

In this embodiment, by collecting the channel-related information on the coordinator and the terminal equipment in communication with the coordinator, that is, collecting channel-related information of a receiver end and a transmitter end in the network, and counting the collected channel-related information, trouble diagnosis may be performed by using a machine learning method. Hence, a trouble related to wireless transmission may be diagnosed.

In an implementation of this embodiment, the apparatus 200 is configured in the coordinator, hence, the acquiring unit 201 may, by information exchange, collect the channel-related information on the coordinator and the channel-related information on the terminal equipment in communication with the coordinator.

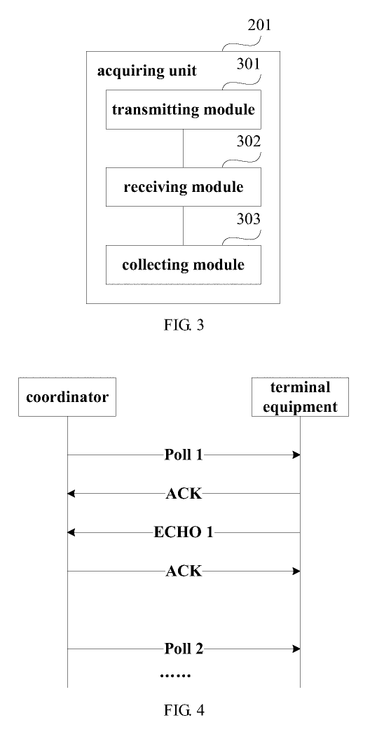

FIG. 3 is a schematic diagram of an implementation of the acquiring unit 201. As shown in FIG. 3, in this implementation, the acquiring unit 201 includes a transmitting module 301, a receiving module 302 and a collecting module 303. The transmitting module 301 is configured to transmit measurement request packets periodically. The receiving module 302 is configured to receive measurement response packets regarding to the transmitted measurement request packets. And the collecting module 303 is configured to collect the channel-related information on the coordinator by using the transmitted measurement request packets and the received measurement response packets, and collect the channel-related information on the terminal equipment by using the received measurement response packets.

In this implementation, the measurement request packets may be, for example, poll packets, and the measurement response packets may be, for example, echo packets. The measurement request packets and the measurement response packets shall be described below taking poll and echo as examples.

In this implementation, the transmitting module 301 may transmit the poll packets periodically, such as transmitting once every 100 ms, a type of the poll packets being not limited in this embodiment. At each time of obtaining a poll packet, the terminal equipment will feed back an echo packet to the coordinator. Hence, the receiving module 302 may receive an echo packet regarding each poll packet transmitted by the transmitting module 301. In this implementation, the echo packet may carry a measurement report obtained by measuring the poll packet and a serial number of the poll packet.

FIG. 4 is a schematic diagram of a processing process of poll and echo. As shown in FIG. 4, in this process, the poll packets are normal periodic packets transmitted by an application layer of the coordinator, such as packets defined in the IEEE 802.15.4 standard. After each time of correctly receiving the packets, the terminal equipment will transmit a MAC layer ACK to the coordinator. In this implementation, the terminal equipment will also transmit an echo packet to the coordinator. A payload of the echo packet may include a measured RSSI, a correlation value, and the number of error bits, etc. In the example shown in FIG. 4, the poll packets are successfully received by the terminal equipment, and there exists only one echo packet after each poll frame.

In this implementation, by exchanging between the transmitting module 301 and the receiving module 302, the collecting module 303 may collect the channel-related information on the coordinator. Here, the channel-related information may be measurement results performed by the coordinator on transmission of the poll packets and correspondingly generated ACK and echo, such as transmission status and the number of times of retransmission of the poll packets, RSSIs of ACK frames, correlation of ACK frames, RSSIs of the echo packets, correlation of the echo packets, and response time (round-trip time), etc., which may be generated by the collecting module 303 of the coordinator.

For example, the collecting module 303 may obtain the information by self-monitoring, communication-monitoring and channel-monitoring. The self-monitoring mainly includes monitoring a status, and configuration, of the coordinator, and so on, such information coming from internal parameters defined in IEEE or other standards. The communication-monitoring refers to monitoring network information from packet communication defined in IEEE or other standards, and may also refer to some communication feature extraction, such as a packet error rate, etc. And the channel-monitoring refers to monitoring channel information relation to physical procedures defined in IEEE or other standards, including some channel feature extraction, such as an RSSI, and an SINR, etc. By the self-monitoring, communication-monitoring and channel-monitoring, the collecting module 303 may obtain the channel-related information on the coordinator. The manner for acquiring the channel-related information on the coordinator by the collecting module 303 is described in this embodiment by taking the self-monitoring, communication-monitoring and channel-monitoring as examples. However, this embodiment is not limited thereto, and in particular implementation, the collecting module 303 may perform any of the above monitoring or a combination thereof, or further perform other monitoring processes to obtain the channel-related information on the coordinator.

In this implementation, by exchanging between the transmitting module 301 and the receiving module 302, the collecting module 303 may further collect the channel-related information on the terminal equipment. The channel-related information may be measurement results performed by the terminal equipment on the received poll packets, such as RSSIs of the poll packets, and correlation of the poll packets, etc. As described above, the measurement results may be generated by the terminal equipment, and transmitted to the coordinator via the above echo packets. And furthermore, the echo packets may contain some information on packet errors, such as the number of error bits of the poll packet.

In this implementation, for each measurement response packet, it may be a normal packet, and may also be an error packet. In this implementation, no matter whether an error occurs in the measurement response packet or not, the above channel-related information may be collected for the measurement response packet, which has no substantial effect on a statistical result. For example, in this implementation, even though the poll packet is damaged at the terminal equipment side, the terminal equipment will still measure the RSSI and correlation of the poll packet, and transmit an echo packet containing a measurement result, in which case, the echo packet may further contain a CRC check and an error flag to indicate that the poll packet is damaged. As the content of the poll packet is predefined and is known to the coordinator and the terminal equipment, the terminal equipment may even further calculate the number of error bits of the poll packet, and contain the number of error bits in the echo packet.

FIG. 5 is a schematic diagram of a processing process of poll and echo. As show in FIG. 5, different from FIG. 4, in this example, a poll packet is damaged. However, only if a synchronization header of the poll packet is correctly decoded, an echo packet will be transmitted after a first failed poll packet. After a retransmitted packet of the first poll packet is received, another echo packet is fed back. Hence, in some cases, for a poll packet, the coordinator may obtain multiple echo packets. Likewise, when an error occurs in an echo packet, the coordinator may still store a measured RRSI and correlation value of the error echo packet.

In this implementation, with the poll and echo mechanism, the acquiring unit 201 may obtain the channel-related information of the receiver end and the transmitter end, and may further perform trouble diagnosis by counting and analyzing the information. A very important advantage of such a poll and echo mechanism is that by collecting information from the coordinator, the channel-related information on the coordinator (referred to as TX log information) and the channel-related information on the terminal equipment (referred to as RX log information) may be obtained, without physically collecting the channel-related information on the terminal equipment at the terminal equipment ends, which greatly lowers complexity of implementation.

In another implementation of this embodiment, the apparatus 200 is configured in another network entity than the coordinator, such as cloud. Then the coordinator may obtain the channel-related information on the coordinator and the channel-related information on the terminal equipment in communication with the coordinator, and report the information to the cloud. Hence, the acquiring unit 201 configured in the cloud may obtain the above information from the coordinator.

In this embodiment, when the detection or the monitoring begins, the coordinator starts to transmit the poll packets periodically, and as described above, receive an echo packet after transmitting each poll packet. The coordinator collects all channel-related information on the coordinator (referred to as TX log information) and the channel-related information on the terminal equipment (referred to as RX log information) based on the received echo packets, and for each time period T (a predetermined period of time), the coordinator may select concerned indices from the above channel-related information, calculate the statistical values of the selected indices, and further perform trouble diagnosis by using a machine learning method and report a diagnosis result, until the above detection or monitoring stops. Thus, there exists a diagnosis result corresponding to each time period. Furthermore, in this embodiment, only statistical data at different time periods are necessary, and performing TX and RX log synchronization is not needed, thereby simplifying the trouble diagnosis procedure.

In this embodiment, the calculating unit 202 may select some indices in the channel-related information on the coordinator, select some indices in the channel-related information on the terminal equipment, and calculate statistical values of the selected indices, so as to obtain a multi-dimensional feature vector, and hence perform trouble diagnosis by using the multi-dimensional feature vector. In this embodiment, as the above indices are selected from the channel-related information in the predetermined period of time, the statistical result reflects a channel state in the period of time.

In an implementation, the indices selected by the calculating unit 202 from the channel-related information on the coordinator include one or more of the following or a combination thereof: transmission status of the measurement request packets (success or failure); a number of times of retransmission of the measurement request packets; received signal strength indicators (RSSIs) of acknowledgement (ACK) of the measurement request packets; RSSIs of measurement response packets regarding to the measurement request packets; a correlation value of the ACK of the measurement request packets; correlation values of the measurement response packets regarding to the measurement request packets; cyclic redundancy check (CRC) error flags of the measurement response packets regarding to the measurement request packets; and response time of the measurement request packets. In an implementation, the indices selected by the calculating unit 202 from the channel-related information on the terminal equipment include one or more of the following or a combination thereof: correlation values of received measurement request packets; and bit error rates (BERs) of the received measurement request packets. Alternatively, the above correlation values may be replaced with signal quality (SQ) or link quality (LQ). This implementation is illustrative only, and in particular implementation, more indices may be selected or one or more of the above indices may be changed as demanded, so as to be adapted to different system specifications.

In this embodiment, after selecting the indices from the above channel-related information, the calculating unit 202 may calculate the statistical values of these selected indices, for the convenience of subsequent trouble diagnosis. In this embodiment, as described above, the calculated statistical values may be a multi-dimensional feature vector. In order to perform subsequent trouble diagnosis, data of each dimension may be normalized, and furthermore, data of each dimension may reflect importance of different levels of the indices by using weights.

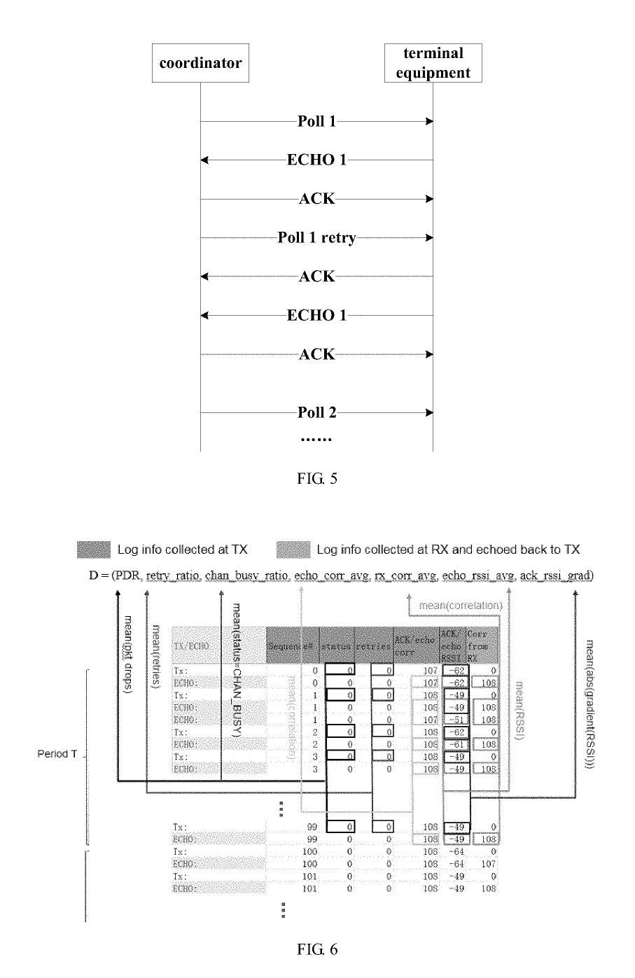

FIG. 6 is a schematic diagram of an implementation of a data model of the statistical data. In this implementation, it is assumed that there exist N periodic poll packets in the time period T (the predetermined period of time), and based on a channel condition, it is possible that each poll packet has no echo packet, or has one echo packet, or has multiple echo packets. As only information on an average value of the echo packets is needed in this application, whether these echo packets are periodic, or how many echo packets are correctly received in the time period T, is not important. For performing subsequent trouble diagnosis, the statistical values are defined as a seven-dimensional feature vector based on the above selected indices collected in the time period T, which includes, as shown in FIG. 6, a packet drop ratio (PDR), a retry ratio(retry_ratio), a channel busy ratio(chan_busy_ratio), an average correlation value of the measurement response packets(echo_corr_avg), an average correlation value of the measurement request packets(rx_corr_avg), an average RSSI of the measurement response packets(echo_rssi_avg), and an average value of all absolute values of gradients of an RSSI of ACK(ack_rssi_grad).

In the example shown in FIG. 6, the PDR refers to a packet drop ratio of N poll packets, which may be obtained from the transmission status of the above measurement request packets. The retry_ratio refers to a ratio of a sum of retransmitted poll packets to N. The chan_busy_ratio refers to a ratio of the number of times of returning a channel busy status to a total number of the poll packets. The echo_corr_avg is an average value of the correlation values of all the echo packets in the time period T. The rx_corr_avg refers to an average value of the correlation values of all the poll packets fed back by the terminal equipment in the time period T. The echo_rssi_avg is an average value of RSSI values of all the echo packets in the time period T. The ack_rssi_grad is an average value of all absolute values of gradients of an RSSI data value sequence of all ACKs in the time period T; that is, the RSSI values of the ACK frames in the time period T form a group of RSSI data values in a temporal order, absolute values of numeral gradients of points of this group of data are averaged, and the obtained average value is the ack_rssi_grad.

In this embodiment, after the statistical values of the above channel-related information are obtained by the calculating unit 202, the diagnosing unit 203 may perform trouble diagnosis by using a statistical machine learning method. The machine learning method is not limited in this embodiment, and many basic machine learning methods may be used for performing trouble diagnosis, such as a K-NN learning method, etc.

In this embodiment, the apparatus 200 may further include a storing unit (not shown), which is configured to pre-store training data, for use in performing trouble diagnosis. The training data may be pre-collected under different error conditions, this can be done manually by creating several errors of interests or automatically by on-line training method.

In this embodiment, for wireless transmission errors, one way of defining different errors (i.e. machine learning outputs) is: a normal state, short-time fading, low received signal strength, interference at a transmitter side, and interference at a receiver side. Such five states are quite common in a wireless system and they behave differently in terms of the pattern of the log statistics.

The normal state indicates that there is no environmental change in this period of time, and the channel condition is very stable. During this state, there is almost no packet drop, no retry packet, and very small variation of RSSIs and correlation values among different packets.

The short-time fading refers to random fading that is caused by sorts of change of environmental. For example, motions of objects near the transmission area, people walking around, trembling or moving of a transceiver will all cause time varying of a channel, in which case RSSI values of packets fluctuate rapidly and packet retry increases sometimes.

The low received signal strength is caused by blockage or shield between a transmitter and a receiver, or decrease of transmission power. For example, in an outdoor area, some large obstacles, such as cars, may have blockage (caused by penetration or diffraction loss) effects. In an indoor area, many people standing between the transmitter and the receiver can even have similar effects, in such situation, a most obvious characteristic is decrease of the RSSI. Sometimes the packet retry and packet drop increases depending on how serious the decrease of the signal strength is. And the low received signal strength will last until the obstacle is removed or the transmission power is increased.

Interference is another important type of error. The ISM band, such as the 2.4 GHz band, is used by many technologies. Hence, this band is very crowded. The interference may possibly come from the neighboring 802.15.4 network, WiFi network, Bluetooth, or a microwave oven. When the interference occurs, a probability of error will increase since the SINR value decreases. A correlation value gives an indication of the SINR of input data. Thus looking into decrease of correlation value as well as a packet drop ratio and retry ratio will give a good indication of interference existence. In order to further locate an interference source, in this embodiment, the interference error is classified into two types, i.e. interference at a transmitter side and interference at a receiver side. To be more specific, decrease of correlation values of the poll packets indicates the interference at a receiver side, while decrease of correlation values of the echo packets indicates the interference at a transmitter side. Furthermore, when the transmission status returns a status code indicating channel busy, it also means that interference at a transmitter side occurs.

In this embodiment, the training data may be obtained in the following manner. For example, first, the TX log and the RX log under the normal and different error cases are collected according to the above-described method at the coordinator end; then, for each training period, statistics is performed according to the above-described method; and finally, for each state, there will exist multiple processed data Dₜᵣₐᵢₙ. This means in the machine learning language that each data Dₜᵣₐᵢₙ is labeled as one state. In this embodiment, for the sake of convenience of description, the processed data are referred to as instances. Hence, in this embodiment, the training data contain multiple instances, each instance corresponding to a trouble type.

In this embodiment, the diagnosing unit 203 may position a trouble by using the above statistical values obtained during real-time communication and the prestored above data.

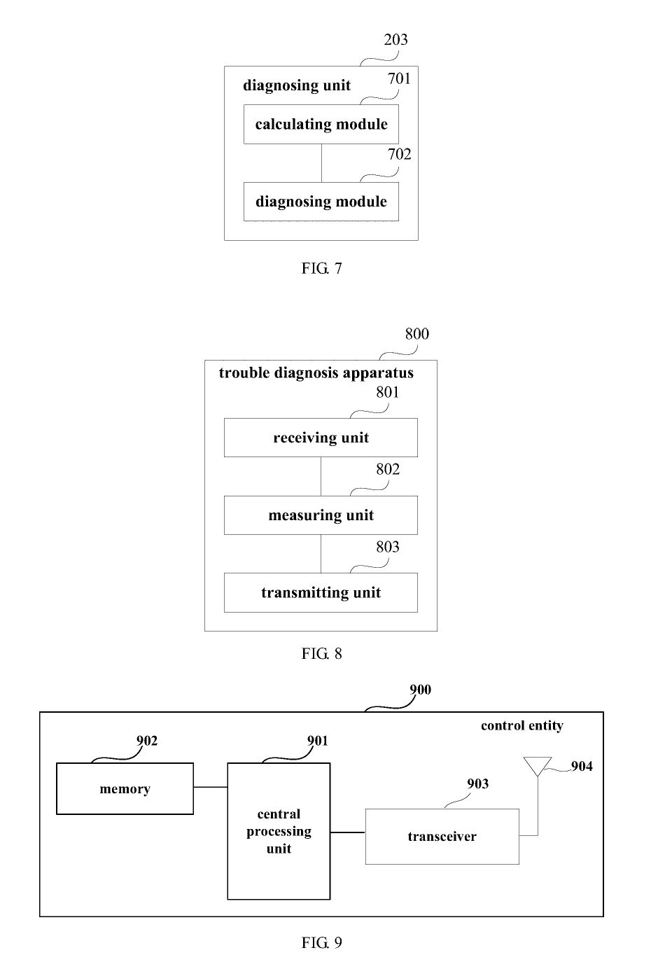

In an implementation, as shown in FIG. 7, the diagnosing unit 203 includes: a calculating module 701 and a diagnosing module 702. The calculating module 701 is configured to calculate distances between the statistical values and all instances of the training data, and select a predetermined number (such as k) of instances from all the instances of the training data in an ascending order of the distances, that is, k closest instances are selected. And the diagnosing module 702 is configured to determine a diagnosis result according to trouble types of the predetermined number of instances, for example, if the number of the instances belonging to the same trouble type in the predetermined number of instances is greater than the number of the instances belonging to other trouble types, determine that the diagnosis result is of the same trouble type, otherwise, if the numbers of the instances belonging to the same trouble types in the predetermined number of instances are equal, determine the trouble diagnosis result according to another policy.

Taking that k=10 as an example, if 8 of the 10 instances belong to the same trouble type and the other 2 instances belong to other trouble types (which may be same or different), that is, the number of the instances belonging to the same trouble type is greater than the number of the instances belonging to other trouble types (8>2), it is determined that a trouble diagnosis result is the trouble type to which the 8 instances belong; and if 4 of the 10 instances belong to trouble type 1, other 4 instances belong to trouble type 2, and rest 2 instances belong to trouble type 3, that is, the number of the instances belonging to trouble type 1 is equal to the number of the instances belonging to trouble type 2 (4=4), it may be deemed that the trouble type is trouble type 1, and it may also be deemed that the trouble type is trouble type 2, or the trouble type may be determined according to other policies.

In this implementation, the above predetermined number is not limited, and may be set as demanded or empirically. And a machine learning algorithm is not limited in this implementation, the K-NN algorithm may be used, and other mature machine learning algorithms may also be used.

In this implementation, with the processing of the diagnosing unit 203, whether a communication process in each time period is normal, or whether short-time fading is generated, or whether the received signal strength is over low, or whether interference at a transmitter side is generated, or whether interference at a receiver side is generated, may be determined. Hence, a trouble may be positioned.

In this embodiment, by collecting channel-related information on the coordinator and the terminal equipment in communication with the coordinator and doing statistics on the collected channel-related information, the trouble diagnosis may be performed by using a machine learning method.

### Embodiment 2

An embodiment of this disclosure provides a trouble diagnosis apparatus, configured at terminal equipment, which is processing at the terminal equipment side corresponding to the apparatus of Embodiment 1, with identical contents being not going to be described herein any further.

FIG. 8 is a schematic diagram of an implementation of the trouble diagnosis apparatus of this embodiment. As shown in FIG. 8, the apparatus 800 includes: a receiving unit 801, a measuring unit 802 and a transmitting unit 803. The receiving unit 801 is configured to receive a measurement request packet such as the poll packet as described above; the measuring unit 802 is configured to perform channel measurement according to the measurement request packet; a measurement manner is not limited in this embodiment, and existing means may be used. No matter whether an error occurs in the measurement request packet or not, channel measurement is performed on it only if a synchronization header of the measurement request packet may be correctly decoded. Furthermore, the measurement request packet may be packet transmitted for a first time, such as poll 1 shown in FIG. 4, and also be packet retransmitted for multiple times, such as poll 1 and poll 1 retry shown in FIG. 5. And the transmitting unit 803 is configured to feed back a channel measurement result via a measurement response packet. The measurement response packet is, for example, an echo packet, and the channel measurement result may include a correlation value, and a BER, etc., of the received measurement request packet.

With the apparatus of this embodiment, the channel-related information on the terminal equipment may be transmitted to the coordinator, so as to assist the coordinator or other network entities (such as cloud) to perform trouble diagnosis.

### Embodiment 3

An embodiment of this disclosure further provides a control entity in a wireless network, such as a coordinator, an access point, a central controller, or cloud; wherein, the control entity includes the trouble diagnosis apparatus as described in Embodiment 1.

FIG. 9 is a schematic diagram of an implementation of the control entity of the embodiment of this disclosure. As shown in FIG. 9, the control entity 900 may include a central processing unit (CPU) 901 and a memory 902, the memory 902 being coupled to the central processing unit 901. In this embodiment, the memory 902 may store various data, and furthermore, it may store a program for information processing, and execute the program under control of the central processing unit 901, so as to receive various information transmitted by terminal equipment, and transmit various information to the terminal equipment.

In an implementation, the functions of the trouble diagnosis apparatus described in Embodiment 1 may be integrated into the central processing unit 901, and the central processing unit 901 carries out the functions of the trouble diagnosis apparatus described in Embodiment 1; for example, the central processing unit 901 may be configured to:

acquire channel-related information on a coordinator and terminal equipment in communication with the coordinator;

select multiple indices in the channel-related information, and calculate statistical values of the multiple indices in a predetermined period of time; and

perform trouble diagnosis by using the statistical values and pre-stored training data, so as to obtain a trouble diagnosis result corresponding to the period of time.

In this embodiment, the functions of the trouble diagnosis apparatus described in Embodiment 1 are incorporated herein, and shall not be described herein any further.

In another implementation, the trouble diagnosis apparatus described in Embodiment 1 and the central processing unit 901 may be configured separately. For example, the trouble diagnosis apparatus described in Embodiment 1 may be configured as a chip connected to the central processing unit 901, with its functions being realized under control of the central processing unit 901.

Furthermore, as shown in FIG. 9, the control entity 900 may also include a transceiver 903, and an antenna 904, etc.; wherein, functions of the above components are similar to the prior art, and shall not be described herein any further. It should be noted that the control entity 900 does not necessarily include all the components shown in FIG. 9. And furthermore, the control entity 900 may include components not shown in FIG. 9, and the prior art may be referred to.

With the control entity of this embodiment, a state or trouble of the wireless network during communication may be diagnosed.

### Embodiment 4

An embodiment of this disclosure further provides terminal equipment in a wireless network, such as an STA, a node, etc.; wherein, the terminal equipment includes the trouble diagnosis apparatus as described in Embodiment 2.

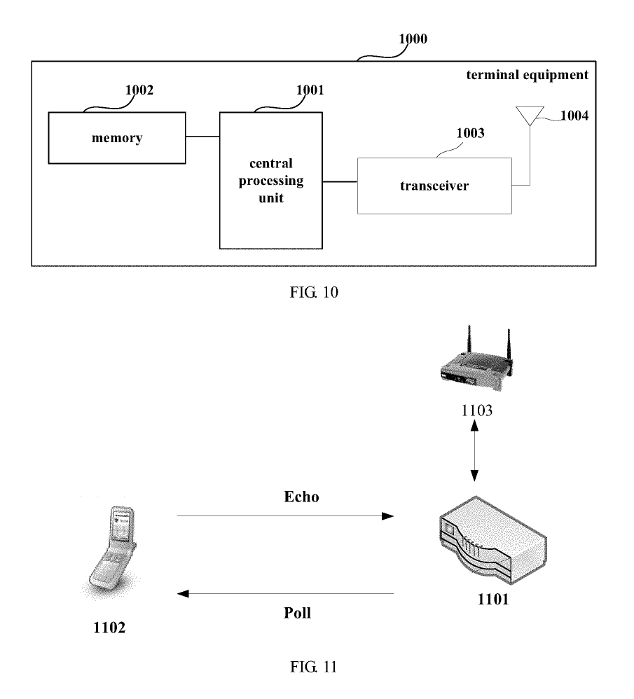

FIG. 10 is a schematic diagram of an implementation of the terminal equipment of the embodiment of this disclosure. As shown in FIG. 10, the terminal equipment 1000 may include a central processing unit (CPU) 1001 and a memory 1002, the memory 1002 being coupled to the central processing unit 1001. In this embodiment, the memory 1002 may store various data, and furthermore, it may store a program for information processing, and execute the program under control of the central processing unit 1001, so as to receive various information transmitted by a control entity, and transmit various information to the control entity.

In an implementation, the functions of the trouble diagnosis apparatus described in Embodiment 2 may be integrated into the central processing unit 1001, and the central processing unit 1001 carries out the functions of the trouble diagnosis apparatus described in Embodiment 2; for example, the central processing unit 1001 may be configured to:

receive a measurement request packet;

perform channel measurement according to the measurement request packet; and

feed back a channel measurement result via a measurement response packet.

In this embodiment, the functions of the trouble diagnosis apparatus described in Embodiment 2 are incorporated herein, and shall not be described herein any further.

In another implementation, the trouble diagnosis apparatus described in Embodiment 2 and the central processing unit 1001 may be configured separately. For example, the trouble diagnosis apparatus described in Embodiment 2 may be configured as a chip connected to the central processing unit 1001, with its functions being realized under control of the central processing unit 1001.

Furthermore, as shown in FIG. 10, the terminal equipment 1000 may also include a transceiver 1003, and an antenna 1004, etc.; wherein, functions of the above components are similar to the prior art, and shall not be described herein any further. It should be noted that the terminal equipment 1000 does not necessarily include all the components shown in FIG. 10. And furthermore, the terminal equipment 1000 may include components not shown in FIG. 10, and the prior art may be referred to.

With the terminal equipment of this embodiment, a control entity in a wireless network may be assisted in performing trouble diagnosis.

### Embodiment 5

An embodiment of this disclosure further provides a communication system. FIG. 11 is a schematic diagram of topology of the system. As shown in FIG. 11, the system 1100 includes a coordinator 1101 and terminal equipment 1102.

In this embodiment, the coordinator 1101 is configured to: acquire channel-related information on the coordinator and the terminal equipment in communication with the coordinator; select multiple indices in the channel-related information, and calculate statistical values of the multiple indices in a predetermined period of time; and perform trouble diagnosis by using the statistical values and pre-stored training data, so as to obtain a trouble diagnosis result corresponding to the period of time;

and the terminal equipment is configured to: receive a measurement request packet; perform channel measurement according to the measurement request packet; and feed back a channel measurement result via a measurement response packet.

In an implementation of this embodiment, the coordinator 1101 may be configured to contain the apparatus as described in Embodiment 1. As the apparatus has been describe in detail in Embodiment 1, its contents are incorporated herein, and shall not be described herein any further.

In another implementation of this embodiment, the system further includes another control entity 1103, such as a gateway, a central controller, and cloud, etc. The control entity 1103 may be configured to contain the apparatus as described in Embodiment 1. As the apparatus has been describe in detail in Embodiment 1, its contents are incorporated herein, and shall not be described herein any further.

In an implementation of this embodiment, the terminal equipment 1102 may be configured to contain the apparatus as described in Embodiment 2. As the apparatus has been describe in detail in Embodiment 2, its contents are incorporated herein, and shall not be described herein any further.

With the system of this embodiment, trouble diagnosis may be performed.

### Embodiment 6

An embodiment of this disclosure provides a trouble diagnosis method, applicable to a control entity in a wireless network, such as a coordinator, an access point, a central controller, or cloud, etc. As principles of the method for solving problems are identical to that of the apparatus in Embodiment 1, the implementation of the apparatus in Embodiment 1 may be referred to for implementation of this method, with identical contents being not going to be described herein any further.

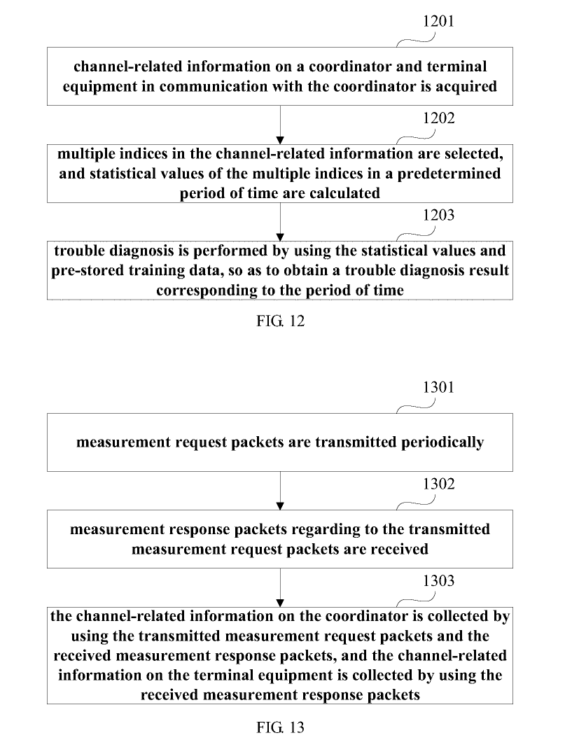

FIG. 12 is a flowchart of the method. As shown in FIG. 12, the method includes:

step 1201: channel-related information on a coordinator and terminal equipment in communication with the coordinator is acquired;

step 1202: multiple indices in the channel-related information are selected, and statistical values of the multiple indices in a predetermined period of time are calculated; and

step 1203: trouble diagnosis is performed by using the statistical values and pre-stored training data, so as to obtain a trouble diagnosis result corresponding to the period of time.

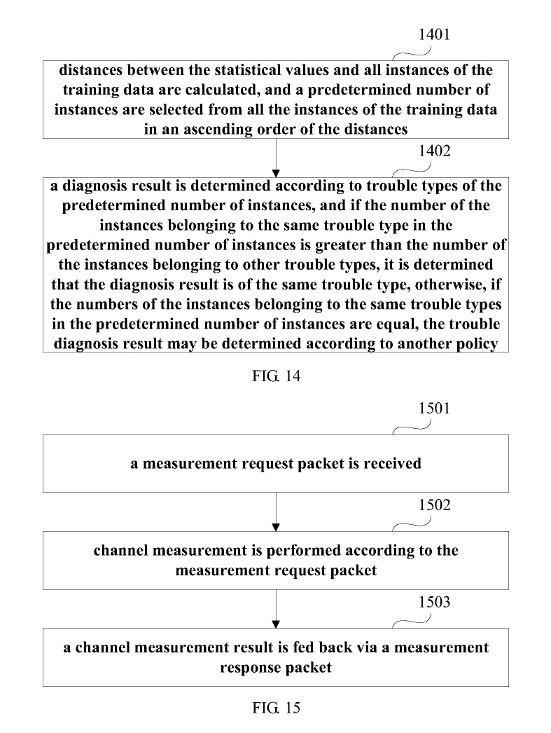

In an implementation of step 1201, the control entity is a coordinator, and the coordinator may be carried out by using a method shown in FIG. 13. Referring to FIG. 13, the method includes:

step 1301: measurement request packets are transmitted periodically;

step 1302: measurement response packets regarding to the transmitted measurement request packets are received; and

step 1303: the channel-related information on the coordinator is collected by using the transmitted measurement request packets and the received measurement response packets, and the channel-related information on the terminal equipment is collected by using the received measurement response packets.

In another implementation of step 1201, the control entity is another network entity than the coordinator, such as cloud, which may receive the channel-related information from the coordinator. In this implementation, the coordinator may acquire the above channel-related information using the method shown in FIG. 13.

In this embodiment, for each measurement response packet, it may be a normal measurement response packet or an error measurement response packet. That is, in this embodiment, it is only needed that the control entity can correctly decode a synchronization header of the measurement response packet.

In this embodiment, the indices selected from the channel-related information on the coordinator may include one or more of the following indices or a combination thereof:

transmission status of measurement request packets;

a number of times of retransmission of the measurement request packets;

received signal strength indicators (RSSIs) of acknowledgement (ACK) of the measurement request packets;

RSSIs of measurement response packets regarding to the measurement request packets;

correlation values of the ACK of the measurement request packets;

correlation values of the measurement response packets regarding to the measurement request packets;

cyclic redundancy check (CRC) error flags of the measurement response packets regarding to the measurement request packets; and

response time of the measurement request packets.

In this embodiment, the indices selected from the channel-related information on the terminal equipment may include one or more of the following indices or a combination thereof:

correlation values of received measurement request packets; and

a bit error rate (BER) of the received measurement request packets.

In this embodiment, the statistical values of the multiple indices in the predetermined period of time may include one or more of the following or a combination thereof:

a packet delivery ratio;

a retry ratio;

a channel state busy ratio;

an average correlation value of the measurement response packets;

an average correlation value of the measurement request packets;

an average RSSI of the measurement response packets; and

an average value of all absolute values of gradients of RSSIs of ACK.

The statistical values may be represented by a seven-dimensional feature vector, with details being as described above, and being not going to be described herein any further.

In this embodiment, training data are prestored for performing trouble diagnosis, the training data containing multiple instances, and each instance corresponding to a trouble type. And the trouble types include one or more of the following or a combination thereof:

normal;

short time fading;

low received signal strength;

interference at a transmitter side; and

interference at a receiver side.

In an implementation of step 1203, the control entity may be carried out by using a method shown in FIG. 14. Referring to FIG. 14, the method includes:

step 1401: distances between the statistical values and all instances of the training data are calculated, and a predetermined number of instances are selected from all the instances of the training data in an ascending order of the distances; and

step 1402: a diagnosis result is determined according to trouble types of the predetermined number of instances, and if the number of the instances belonging to the same trouble type in the predetermined number of instances is greater than the number of the instances belonging to other trouble types, it is determined that the diagnosis result is of the same trouble type, otherwise, if the numbers of the instances belonging to the same trouble types in the predetermined number of instances are equal, the trouble diagnosis result may be determined according to another policy.

With the method of this embodiment, trouble diagnosis may be performed.

### Embodiment 7

An embodiment of this disclosure provides a trouble diagnosis method, applicable to terminal equipment in a wireless network, such as an STA, or a node, etc. As principles of the method for solving problems are identical to that of the apparatus in Embodiment 2, the implementation of the apparatus in Embodiment 2 may be referred to for implementation of this method, with identical contents being not going to be described herein any further.

FIG. 15 is a flowchart of the method. As shown in FIG. 15, the method includes:

step 1501: a measurement request packet is received;

step 1502: channel measurement is performed according to the measurement request packet; and

step 1503: a channel measurement result is fed back via a measurement response packet.

In this embodiment, the channel measurement result includes one or more of the following or a combination thereof:

a correlation value of the received measurement request packet; and

a BER of the received measurement request packet.

In this embodiment, the measurement request packet may be a normal measurement request packet or may be an error measurement request packet, only if a synchronization header of the measurement request packet may be correctly decoded.

In this embodiment, the measurement request packet may be a measurement request packet transmitted for a first time or may be a measurement request packet retransmitted for multiple times.

With the method of this embodiment, a control entity in a wireless network may be assisted in performing trouble diagnosis.

An embodiment of the present disclosure provides a computer readable program code, which, when executed in a control entity in a wireless network, will cause a computer to carry out the method as described in Embodiment 1 in the control entity in the wireless network.

An embodiment of the present disclosure provides a computer readable medium, including a computer readable program code, which will cause a computer to carry out the method as described in Embodiment 1 in a control entity in a wireless network.

An embodiment of the present disclosure provides a computer readable program code, which, when executed in terminal equipment in a wireless network, will cause a computer to carry out the method as described in Embodiment 2 in the terminal equipment in the wireless network.

An embodiment of the present disclosure provides a computer readable medium, including a computer readable program code, which will cause a computer to carry out the method as described in Embodiment 2 in terminal equipment in a wireless network.

The above apparatuses and methods of the present disclosure may be implemented by hardware, or by hardware in combination with software. The present disclosure relates to such a computer-readable program that when the program is executed by a logic device, the logic device is enabled to carry out the apparatus or components as described above, or to carry out the methods or steps as described above. The present disclosure also relates to a storage medium for storing the above program, such as a hard disk, a floppy disk, a CD, a DVD, and a flash memory, etc.

The present disclosure is described above with reference to particular embodiments. However, it should be understood by those skilled in the art that such a description is illustrative only, and not intended to limit the protection scope of the present disclosure. Various variants and modifications may be made by those skilled in the art according to the spirits and principles of the present disclosure, and such variants and modifications fall within the scope of the present disclosure.

1. A trouble diagnosis apparatus, comprising:
an acquiring unit configured to acquire channel-related information on a coordinator and terminal equipment in communication with the coordinator;
a calculating unit configured to select multiple indices in the channel-related information, and calculate statistical values of the multiple indices in a predetermined period of time; and
a diagnosing unit configured to perform trouble diagnosis by using the statistical values and pre-stored training data, so as to obtain a trouble diagnosis result corresponding to the period of time.

2. The apparatus according to claim 1, wherein the acquiring unit comprises:
a transmitting module configured to transmit measurement request packets periodically;
a receiving module configured to receive measurement response packets regarding to the transmitted measurement request packets; and
a collecting module configured to collect the channel-related information on the coordinator by using the transmitted measurement request packets and the received measurement response packets, and collect the channel-related information on the terminal equipment by using the received measurement response packets.

3. The apparatus according to claim 2, wherein the measurement response packet is a normal measurement response packet or an error measurement response packet.

4. The apparatus according to claim 2, wherein the indices selected from the channel-related information on the coordinator comprise one or more of the following indices or a combination thereof:
transmission status of measurement request packets;
a number of times of retransmission of the measurement request packets;
received signal strength indicators (RSSIs) of acknowledgement (ACK) of the measurement request packets;
RSSIs of measurement response packets regarding to the measurement request packets;
correlation values of the ACK of the measurement request packets;
correlation values of the measurement response packet regarding to the measurement request packets;
cyclic redundancy check (CRC) error flags of the measurement response packets regarding to the measurement request packets; and
response time of the measurement request packets.

5. The apparatus according to claim 2, wherein the indices selected from the channel-related information on the terminal equipment comprise one or more of the following indices or a combination thereof:
correlation values of received measurement request packets; and
a number of error bits of the received measurement request packets.

6. The apparatus according to claim 2, wherein the statistical values of the multiple indices in the predetermined period of time comprise one or more of the following or a combination thereof:
a packet delivery ratio;
a retry ratio;
a channel state busy ratio;
an average correlation value of the measurement response packets;
an average correlation value of the measurement request packets;
an average RSSI of the measurement response packets; and
an average value of all absolute values of gradients of RSSIs of ACKs.

7. The apparatus according to claim 1, wherein the diagnosing unit comprises:
a calculating module configured to calculate distances between the statistical values and all instances of the training data, and select a predetermined number of instances from all the instances of the training data in an ascending order of the distances; and
a diagnosing module configured to determine a diagnosis result according to trouble types of the predetermined number of instances, and if the number of the instances belonging to the same trouble type in the predetermined number of instances is greater than the number of the instances belonging to other trouble types, determine that the diagnosis result is of the same trouble type, otherwise, if the numbers of the instances belonging to the same trouble types in the predetermined number of instances are equal, determine the trouble diagnosis result according to another policy.

8. The apparatus according to claim 7, wherein the trouble types comprise one or more of the following or a combination thereof:
normal;
short time fading;
low received signal strength;
interference at a transmitter side; and
interference at a receiver side.

9. A trouble diagnosis apparatus, comprising:
a receiving unit configured to receive a measurement request packet;
a measuring unit configured to perform channel measurement according to the measurement request packet; and
a transmitting unit configured to feed back a channel measurement result via a measurement response packet.

10. The apparatus according to claim 9, wherein the channel measurement result comprises one or more of the following or a combination thereof:
a correlation value of a received measurement request packet; and
a number of error bits of the received measurement request packet.

11. The apparatus according to claim 9, wherein the measurement request packet is a normal measurement request packet or an error measurement request packet.

12. The apparatus according to claim 9, wherein the measurement request packet is a measurement request packet transmitted for a first time or a measurement request packet retransmitted for multiple times.

13. A communication system, comprising a coordinator and terminal equipment in communication with the coordinator; wherein,
the coordinator is configured to:
acquire channel-related information on the coordinator and the terminal equipment in communication with the coordinator;
select multiple indices in the channel-related information, and calculate statistical values of the multiple indices in a predetermined period of time; and
perform trouble diagnosis by using the statistical values and pre-stored training data, so as to obtain a trouble diagnosis result corresponding to the period of time;
and the terminal equipment is configured to:
receive a measurement request packet;
perform channel measurement according to the measurement request packet; and
feed back a channel measurement result via a measurement response packet.
